(19) United States
(12) Patent Application Publication
(10) Pub. No.: US 2014/0291238 A1
(43) Pub. Date: Oct. 2, 2014

(54) SCREEN WITH INCREASED SCREENING AREA

(71) Applicant: M-I LLC, Houston, TX (US)

(72) Inventors: Eric Cady, Florence, KY (US); Brian S. Carr, Florence, KY (US)

(21) Appl. No.: 13/852,981

(22) Filed: Mar. 28, 2013

(51) Int. Cl. B01D 29/07; B01D 29/01

(52) U.S. Cl. CPC B01D 29/071; B01D 29/012
USPC 210/498; 264/275; 264/271.1

(57) ABSTRACT

This disclosure is drawn to systems, devices, apparatuses, and/or methods, related to screening fluid. Specifically, the disclosed systems, devices, apparatuses, and/or methods relate to screening fluid using a screen having an increased screening area. Some example apparatuses may include a screen frame including a base portion and a plurality of projections extending from the base portion in an undulating three-dimensional configuration. Some example apparatuses may also include a screen fused to the plurality of projections such that at least a portion of the plurality of projections extends through the screen.

### BACKGROUND

Many applications require that fluids be screened to remove solids (such as foreign objects, rocks, and particulates). Some examples include water treatment applications, hazardous material handling applications, and drilling applications. For example, in oilfield environments, fluid used in oilfield activities must be filtered via a screening process. Conventionally, screens used in such screening processes are flat screens mounted on metal frames. Construction and repair of such metal screens is time consuming, inefficient, and costly. Metal screens also put a great amount of wear on drilling equipment such as shaker screen beds.

In many oilfield environments, operating space is extremely limited and equipment size and weight limits are important. Conventional metal screens are heavy and difficult to install and remove.

Further, efficient screening reduces the time required to filter the fluid. Increased fluid capacity of screens allows the filtering process to complete quickly.

### BRIEF DESCRIPTION OF THE DRAWINGS

The foregoing and other features of the present disclosure will become more fully apparent from the following description and appended claims, taken in conjunction with the accompanying drawings. Understanding that these drawings depict several embodiments in accordance with the disclosure and are, therefore, not to be considered limiting of its scope, the disclosure will be described with additional specificity and detail through use of the accompanying drawings.

In the drawings:

FIG. 1 is a perspective view of an example apparatus for screening fluid;

FIG. 2 is another perspective view of the example apparatus for screening fluid of FIG. 1;

FIG. 3 is a side view of a portion of an example apparatus for screening fluid;

FIG. 4 is a side view of a portion of an example apparatus for screening fluid;

FIG. 5 is a side view of a portion of another example apparatus for screening fluid; and

FIG. 6 is a side view of a portion of yet another example apparatus for screening fluid, each arranged in accordance with at least an embodiment of the present disclosure.

### DETAILED DESCRIPTION

In the following detailed description, reference is made to the accompanying drawings, which form a part hereof. In the drawings, similar symbols identify similar components, unless context dictates otherwise. The illustrative embodiments described in the detailed description and drawings are not meant to be limiting and are for explanatory purposes. Other embodiments may be utilized, and other changes may be made, without departing from the spirit or scope of the subject matter presented herein. It will be readily understood that the aspects of the present disclosure, as generally described herein, and illustrated in the drawings, may be arranged, substituted, combined, and designed in a wide variety of different configurations, each of which are explicitly contemplated and made part of this disclosure.

This disclosure is drawn to systems, devices, apparatuses, and/or methods, related to screening fluid. Specifically, the disclosed systems, devices, apparatuses, and/or methods relate to screening fluid using a screen having an increased screening area.

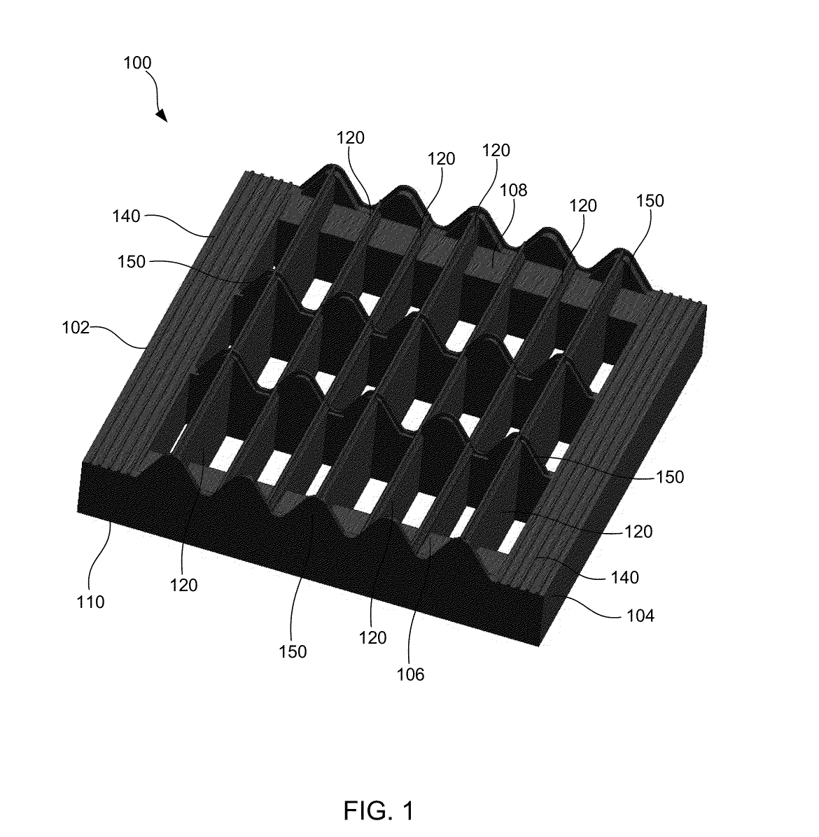

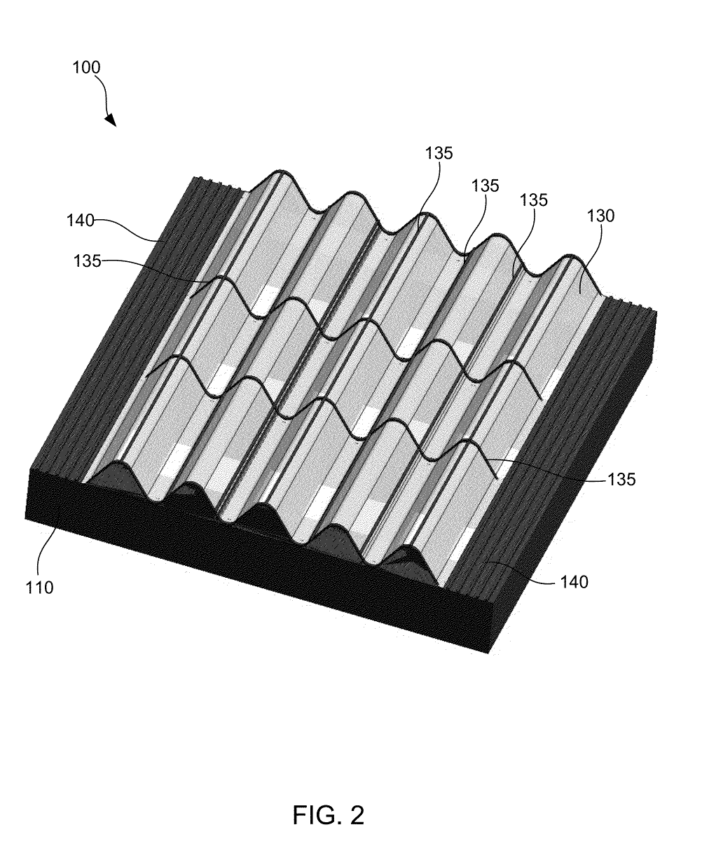

FIGS. 1 and 2 are perspective views of an example apparatus for screening fluid, in accordance with at least an embodiment of the present disclosure. An example apparatus may include a screen frame 100 having a base portion 110 and a plurality of projections 120. In some examples, the screen frame 100 may be made of a composite material. For example, the screen frame 100 may be molded as a unitary frame. Projections 120 may extend from base portion 110. Some projections 120 may extend a first distance (i.e., height) from base portion 110, while some projections 120 may extend a second distance (i.e., height) from base portion 110. In some examples, the first distance is different than the second distance. Screen frame 100 may be a composite material such as composite polymers and/or plastics.

In some examples, screen frame 100 may be manufactured as one piece or may be assembled from multiple pieces. Screen frame 100 (or pieces thereof) may be manufactured using known techniques, including, for example, injection molding.

In some examples, screen frame 100 may include a first end 102 and a second end 104, which may be substantially parallel. First member 106 and second member 108 may both separately be coupled to first end 102 and second 104. First member 106 and second member 108 may also be substantially parallel to each other.

In some examples, base portion 110 may extend in a horizontal plane (e.g., parallel to the Earth's surface). In such examples, projections 120 may extend perpendicular to such horizontal plane (e.g., perpendicular to the Earth's surface).

In some examples, screen frame 100 may include support(s) 150 coupled to projection(s) 120. Supports 150 may contact and/or support screen 130. In some examples, projection(s) 120 and support(s) 150 may be coupled at a various heights. For example, one projection 120 may meet support 150 at a first height, while another projection 120 may meet support 150 at a different, second height. In some examples, supports 150 may intersect projection(s) 120 at about a 90 degree angle such that supports 150 and projections 120 exist in in substantially perpendicular planes. Example supports 150 may be formed from composite materials and/or non-composite materials.

In some examples, supports 150 and projections 120 may include and/or may form openings and/or apertures in which fluid may flow through after flowing through screen 130. In this manner, supports 150 and projections 120 may not restrict the flow of fluid, thus the flow of fluid through the screening apparatus as a whole may not be impeded.

Screen frame 100 may receive and/or engage a screen (e.g., a three-dimensional screen) 130 for screening fluid. Projections 120 may support and/or contact screen 130. Some example screens 130 may be wire cloth screens. Screen frame 100 may include a coupling portion 140 that allows screen 130 to be coupled (e.g., temporarily, permanently) to screen frame 100. In some examples, coupling portion 140 may be coupled to or integrated with base portion 110. More than one screen 130 may be coupled to screen frame 100 simultaneously. Each screen 130 may be coupled to screen frame 100 using known coupling mechanisms, including, for example, screws, glues, dovetail joints, plastic welding, and the like.

Some example screens 130 may include screen reinforcement(s). Screen reinforcement(s) may provide some rigidity and/or structure to screen 130. In this manner, screen 130 may more easily conform to the three-dimensional shape formed by the configuration of projections 120 and supports 150. Some example screen reinforcement(s) may include metal (e.g., steel) and/or composite (e.g., glass filled polypropylene) materials.

Some example apparatuses for screening fluid may be manufactured by molding a screen frame 100 from a composite material. A screen 130 (e.g., wire cloth) may be positioned adjacent the top surface of screen frame 100. Screen 130 may then be fused to screen frame 100.

In some examples, screen frame 100 may include molding a composite material around reinforcement material(s) (which may include composite materials and/or non-composite materials)

In some examples, screen 130 may be fused to screen frame 100 by melting the composite material such that a portion of the composite material flows through screen 130. The composite material may be cured through and/or around screen 130, effectively fusing screen 130 to screen frame 100. In some examples, fusing may include applying a fusing source to (or at least near) a top surface of screen frame 100. Example fusing sources may include a heat source (e.g., hot plate) and/or vibration source (e.g., ultrasonic welder).

Some example apparatuses for screening fluid may be manufactured by molding screen frame 100 from a composite material, where screen frame 100 includes projections 120 forming a three-dimensional configuration. Wire cloth 130 may be fused to at least a portion of projections 120. Fusing may include heating at least a portion of projections 120 such that the heated projections 120 at least partially flow and/or extend through the screen 130. Heated projections 120 may then cure to set as a fusing mechanism.

In some examples, screen frame 130 may also include a supports 150 intersecting projections 120. Fusing may include heating at least a portion of projections 120 and/or supports 150 such that the heated projections 120 and/or supports 150 at least partially flow and/or extend through the screen 130.

In some examples, projections 120 may be removable and/or replaceable, thus creating a modular system. In some examples, a small piece of screen 130 may be fused to a portion of projections 120 to form modular pieces. Several modular pieces of screen 130 fused to projections may be simultaneously coupled to screen frame 100. In this manner, maintenance may occur on only a subset of the entire apparatus, such as one modular piece. For example, if screen 130 includes a tear or hole, only that specific modular piece with a damaged screen may be removed for repair or replacement.

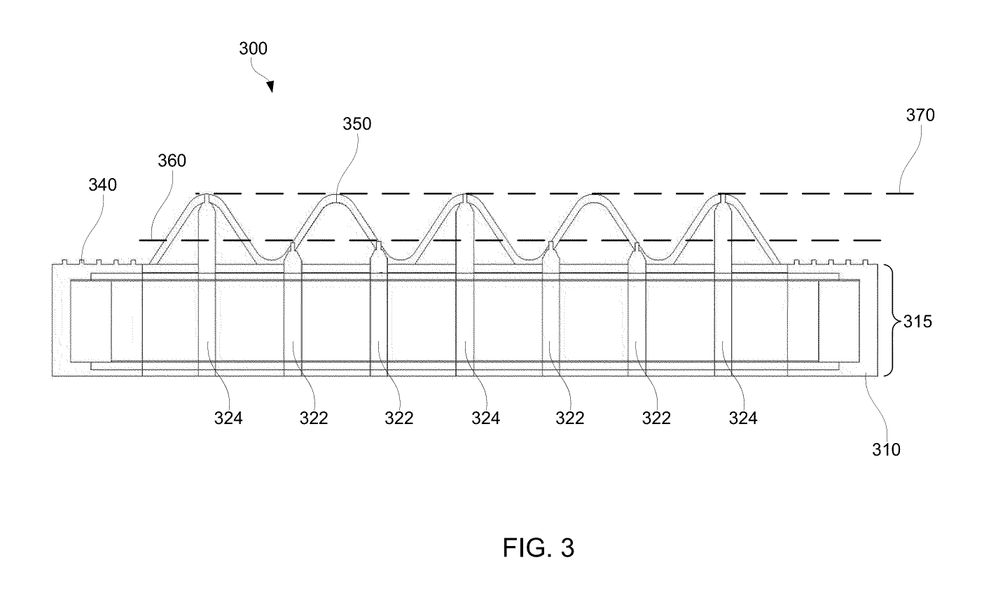

FIG. 3 is a side view of a portion of an example apparatus for screening fluid, in accordance with at least an embodiment of the present disclosure. Screen frame 300 may include a base portion 310 having a base height 315, projection(s) 322, 324, coupling portion(s) 340, and/or support(s) 350. Support(s) 350 may be coupled to projection(s) 320. Projections 322, 324 and/or supports 350 may contact and/or support a screen. In FIG. 3, projection(s) 322, 324 and support(s) 350 are coupled at different heights. Specifically, projections 322 may be coupled to support 350 at a first height (from base portion 310 to line 360), while projections 324 may be coupled to support 350 at a greater second height (from base portion 310 to line 370). In some examples, first height and second height are greater that base height 315. In this manner, projections 322, 324 and supports 350 form a wavelike shape or pattern (as viewed from the side or top of screen frame).

A three-dimensional screen may contact and rest upon projections 322, 324 and/or supports 350. In some examples, the three-dimensional screen may be formed in a wavelike shape similar to the wavelike shape formed by projections 322, 324 and supports 350. In this manner, three-dimensional screen may closely mimic or conform to projections 322, 324 and supports 350. The three-dimensional screen may extend substantially along the entire length and/or the entire width of the example apparatus for screening fluid.

A three-dimensional shape (such as a wavelike shape) may increase the surface area of screen 130. In this manner, compared to a conventional planar screen, more fluid may flow through screen 130 because of the increased surface area. Since more fluid may flow through screen 130, screening capacity and/or rate may be increased due to the three-dimensional shape.

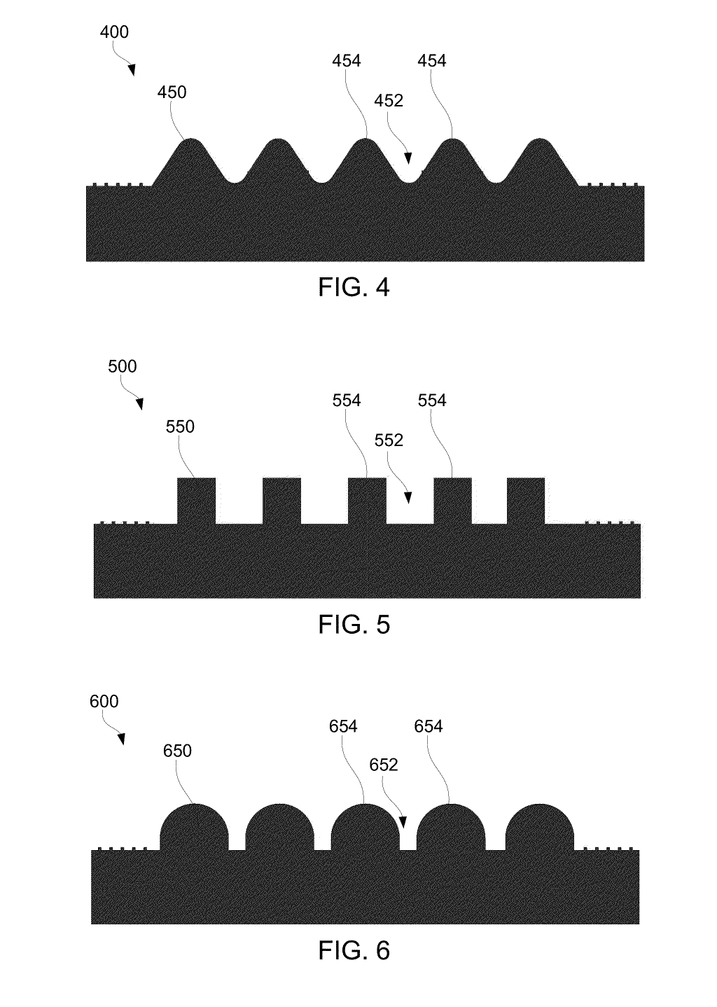

FIG. 4 is a side view of a portion of an example apparatus for screening fluid, in accordance with at least an embodiment of the present disclosure. Screen frame 400 may include a base portion, projection(s), coupling portion(s), and/or support(s) 450. Like FIG. 3, projections and supports 450 form a wavelike shape or pattern (as viewed from the side or top of screen frame 400). There may be a gap or valley 452 between peaks 454 of supports 450. A three-dimensional screen may contact and rest upon the projections and/or supports 450. In some examples, the three-dimensional screen may be formed in a wavelike shape similar to the wavelike shape formed by the projections and supports 450. In this manner, three-dimensional screen may closely mimic or conform to the wavelike shape of the projections and supports 450.

FIG. 5 is a side view of a portion of another example apparatus for screening fluid, in accordance with at least an embodiment of the present disclosure. Screen frame 500 may include a base portion, projection(s), coupling portion(s), and/or support(s) 550. The projections and supports 550 form rectangular and/or block shapes (as viewed from the side of screen frame 500). There may be a gap or valley 552 between peaks 554 of supports 550. A three-dimensional screen may contact and rest upon the projections and/or supports 550. In some examples, the three-dimensional screen may be formed in a rectangular and/or block shape similar to the rectangular and/or block shape formed by the projections and supports 550. In this manner, three-dimensional screen may closely mimic or conform to the rectangular and/or block shape of the projections and supports 550.

FIG. 6 is a side view of a portion of yet another example apparatus for screening fluid, in accordance with at least an embodiment of the present disclosure. Screen frame 600 may include a base portion, projection(s), coupling portion(s), and/or support(s) 650. The projections and supports 650 form circular shapes (as viewed from the side of screen frame 600). There may be a gap or valley 652 between peaks 654 of supports 650. A three-dimensional screen may contact and rest upon the projections and/or supports 650. In some examples, the three-dimensional screen may be formed in a circular shape similar to the circular shape formed by the projections and supports 650. In this manner, three-dimensional screen may closely mimic or conform to the circular shape of the projections and supports 650.

In some aspects of the present disclosure, an apparatus for screening fluid may include a screen frame having a base portion and a projections extending from the base portion. At least one projection may extend a first distance from the base portion, and at least one projection may extend a second distance from the base portion.

In some aspects of the present disclosure, an apparatus for screening fluid may include a frame, projections, and a three-dimensional screen. The projections may be coupled to the frame. At least one projection may have first height greater than the frame's height, and at least one projection may have second height greater than the first height. The three-dimensional screen may contact and/or rest on the projections. The three-dimensional screen may substantially conform to a three-dimensional shape formed by the configuration of the projections.

In some aspects of the present disclosure, an apparatus for screening fluid may include a first end, a second end, a first member, a second member, and projections. The first end and the second end may be substantially parallel to each other. The first member and the second member may be separately coupled to the first end and the second end, and may be substantially parallel to each other. The projections may be substantially parallel to the first end and the second end. Each projection may be coupled to the first member and the second member. At least one projection may have a first height, and at least one projection may have a second height.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An apparatus, comprising:
a screen frame comprising:
a base portion; and
a plurality of projections extending from the base portion in an undulating three-dimensional configuration; and
a screen fused to the plurality of projections such that at least a portion of the plurality of projections extends through the screen.

2. The apparatus of claim 1, wherein the base portion and the plurality of projections are molded together as a single piece.

3. The apparatus of claim 1, wherein the screen comprises a three-dimensional configuration that substantially conforms to the plurality of projections.

4. The apparatus of claim 1, wherein the screen comprises wire cloth.

5. The apparatus of claim 1, wherein the base portion includes a coupling portion on one or more surface of the base portion, the coupling portion adapted to at least temporarily couple a screen to the screen frame.

6. The apparatus of claim 1,
wherein the base portion extends in a horizontal plane; and
wherein each projection of the plurality of projections extends perpendicular to the horizontal plane of the base portion.

7. The apparatus of claim 1, wherein the screen frame further comprises a plurality of supports coupled to and intersecting at least one of the plurality of projections, wherein each of the plurality of supports is adapted to support the screen.

8. The apparatus of claim 7, wherein the plurality of supports, the plurality of projections, and the base portion as molded together as a single piece

9. The apparatus of claim 1, wherein at least one of the base portion and the plurality of projections comprises a composite material.

10. A method, comprising:
molding a screen frame from a composite material;
positioning a wire cloth adjacent a top surface of the screen frame; and
fusing the wire cloth to the screen frame.

11. The method of claim 10, wherein molding the screen frame comprises molding the composite material around one or more reinforcement material.

12. The method of claim 11, wherein the one or more reinforcement material comprises one or more non-composite material.

13. The method of claim 10, wherein fusing the wire cloth to the screen frame comprises melting at least a portion of the composite material such that a portion of the composite material flows through the wire cloth.

14. The method of claim 13, wherein the composite material is cured to fuse the wire cloth to the screen frame.

15. The method of claim 10, wherein fusing the wire cloth to the screen frame comprises applying a fusing source to the top surface of the screen frame.

16. The method of claim 15, wherein the fusing source comprises at least one of a heat source and vibration source.

17. A method, comprising:
molding a screen frame from a composite material, the screen frame having a plurality of projections forming a three-dimensional configuration; and
fusing a wire cloth to at least a portion of the plurality of projections;

18. The method of claim 17, wherein fusing the wire cloth to at least a portion of the plurality of projections comprises:
heating at least a portion of the plurality of projections such that the heated plurality of projections at least partially flow through the wire cloth; and
curing the heated plurality of projections.

19. The method of claim 17,
wherein the screen frame further comprises a plurality of supports intersecting the plurality of projections; and
wherein fusing the wire cloth to at least a portion of the plurality of projections further comprises fusing wire cloth to the plurality of projections and the plurality of supports.

20. The method of claim 17, wherein at least one of the plurality of projections forming a three-dimensional configuration is removable from the screen frame.
